(19) United States
(12) Patent Application Publication
(10) Pub. No.: US 2021/0155548 A1
(43) Pub. Date: May 27, 2021

(54) PREPARATION AND APPLICATION OF A LOW-B HIGH-RESISTANCE HIGH-TEMPERATURE THERMISTOR MATERIAL WITH WIDE TEMPERATURE RANGE

(71) Applicant: ZKLM New Material (Yangzhou) Co., Ltd., Jiangsu (CN)

(72) Inventors: Li Ni, Jiangsu (CN); Mingya Li, Jiangsu (CN); Yang Zhou, Jiangsu (CN); Yu Zhang, Jiangsu (CN); Chao Zhang, Jiangsu (CN); Ai Feng Li, Jiangsu (CN)

(73) Assignee: ZKLM New Material (Yangzhou) Co., Ltd., Jiangsu (CN)

(21) Appl. No.: 16/941,514

(22) Filed: Jul. 28, 2020

(30) Foreign Application Priority Data
Nov. 22, 2019 (CN) 201911153484.2

(51) Int. Cl. C04B 35/495; C04B 35/626; C04B 35/645; C04B 41/00; C04B 41/45; C04B 41/51; C04B 41/88; H01C 7/04; H01C 17/00; C23C 30/00

(52) U.S. Cl. CPC C04B 35/495; C04B 2235/9607; C04B 35/62675; C04B 35/6455; C04B 41/009; C04B 41/4539; C04B 41/5122; C04B 41/88; H01C 7/04; H01C 17/00; C23C 30/00; C04B 2235/3256; C04B 2235/3255; C04B 2235/604; C04B 2235/6567; C04B 35/6262

(57) ABSTRACT

An object of the present disclosure is to provide the preparation and application of a low-B high-resistance high-temperature thermistor material with wide temperature range. The thermistor material uses CaCO₃, Y₂O₃, Nb₂O₅, CeO₂ and MoO₃ as raw materials. The Ca_{1-y}Y_{y}MoO₄-xCeNbO₄ (1≤x≤3, 0.01≤y≤0.2) high-temperature thermistor material having low-B high-resistance and wide temperature region is obtained by mixing grinding, calcination, cold isostatic pressing, high-temperature sintering and coating electrode. The material constant B_{200° C./600° C.} is 1800 K-4000 K, and the resistivity at 25° C. is 8.0×10⁵ Ω·cm-6.0×10⁷ Ω·cm. The low-B high-resistance wide temperature range high-temperature thermistor material prepared by the disclosure has stable performance and good consistency. The thermistor material has obvious negative temperature coefficient characteristics in the range of 25° C.-1000° C. and is suitable for manufacturing wide temperature range high-temperature thermistor.

### CROSS-REFERENCE TO RELATED APPLICATION

This application claims the priority benefit of China application serial no. 201911153484.2, filed on Nov. 22, 2019. The entirety of the above-mentioned patent application is hereby incorporated by reference herein and made a part of this specification.

### BACKGROUND

### Technical Field

The disclosure belongs to a thermistor material, in particular to a low-B high-resistance wide temperature range high-temperature thermistor material and its preparation method and application. The thermistor material has an obvious negative temperature coefficient characteristic in the temperature range of 25° C.-1000° C., and is a new thermistor material suitable for manufacturing a wide temperature range high-temperature thermistor.

### Description of Related Art

The temperature sensor has been widely used in household appliances, industrial machinery, medical equipment, aerospace, automobile and many other fields. Especially in the automotive industry, the high-temperature temperature sensor is used to monitor the temperature of automobile exhaust gas, thus improving combustion efficiency and optimizing gas emissions. At present, platinum resistance is mainly used for high temperature detection at home and abroad. It has a long history for measuring the temperature below 600° C. The development mainly focuses on thin and thick platinum films, that is, film resistance temperature detector with a layer of film on ceramic materials. After the latest improvement, the measurement temperature can reach up to 850° C. The platinum film temperature sensor relies on the linear characteristic of the resistance temperature to realize temperature measurement. When the temperature is lower than 500° C., it can be fully linearized. However, due to the characteristics of platinum metal materials, it is difficult to realize the linearization at high temperatures. In addition, in order to improve the sensitivity, it is necessary to use manufacturing technology to increase the size of the element, which makes the response time of the sensor increase with the size, resulting in the contradiction of performance improvement. Therefore, it is necessary to explore new sensitive materials with good electrical properties at high temperatures.

Negative temperature coefficient (NTC) thermistor with high sensitivity, fast response and small volume is considered as a potential high-temperature sensor instead of a platinum resistor. However, the traditional Mn—Co—Ni—O spinel thermistor materials are mainly used below 300° C., which brings a new challenge to the development of new high-temperature thermistor materials. The structure of pyrochlore is composed of a double cation coordination polyhedron, which has better adjustability and high temperature stability than spinel and perovskite. In recent years, complex oxide Ca—Ce—Nb—M—O (M is W or Mo) materials have excellent high temperature NTC performance and have a good application prospect in the field of NTC thermistor. However, the B value of Ca—Ce—Nb—Mo—O material is large (>5000 K), which can't meet the wide temperature range application, so it is necessary to reduce its B value to achieve wide temperature range application.

At present, the low-B high-resistance wide temperature range high-temperature thermistor material has a broad application prospect in the field of wide temperature range high-temperature measurement and control, and it is still in a blank slate in the field of the thermistor. Generally speaking, the higher the value of thermistor B is, the higher the resistivity is, and vice versa. Therefore, it is difficult to reduce the B value of the material and keep the resistivity unchanged in the field of manufacturing low-B high resistance wide temperature high temperature thermistor materials.

### SUMMARY

In view of the problems existing in the prior art, an object of the present disclosure is to provide a low-B high-resistance wide temperature range high temperature thermistor material. The thermistor material prepared by the disclosure has stable performance and good consistency. The thermistor material has an obvious negative temperature coefficient characteristic in the range of 25° C.-1000° C. and is suitable for manufacturing high-temperature thermistor with a wide temperature range.

For the purpose of the disclosure, a low-B high-resistance wide temperature range high-temperature thermistor material described in the disclosure is characterized in that the thermistor material is prepared by CaCO₃, Nb₂O₅, CeO₂, MoO₃ and Y₂O₃; the thermistor material is a complex oxide containing Ca, Y, Mo, Ce and Nb.

Wherein, the chemical composition of the thermistor material is composed of Ca_{1-y}Y_{y}MoO₄-xCeNbO₄, wherein 1≤x≤3, 0.01≤y≤0.2. x represents the mole number of CeNbO₄, y represents the mole number of element Y, and the electrical properties can be adjusted by x and y, respectively.

As preferred, the molar ratio of Ca, Y, Mo, Ce and Nb in the mixed oxide containing Ca, Y, Mo, Ce and Nb is (0.8-0.99): (0.01-0.2):1:(1-3):(1-3).

Furthermore, the molar ratio of Ca, Y, Mo, Ce and Nb in the mixed oxides containing Ca, Y, Mo, Ce and Nb is (0.85-0.95):(0.05-0.15):1:(1.5-2.5):(1.5-2.5).

The preparation method of the low-B high-resistance wide temperature range high-temperature thermistor material comprises the following steps:

step a, weigh CaCO₃, Nb₂O₅, CeO₂, MoO₃ and Y₂O₃ respectively and mix them. Grind the mixed raw materials for 5-10 hours to obtain powder A;

step b, calcine powder in step a at 1000° C.-1100° C. for 3-5 hours, and grind for 5-10 hours to obtain powder B;

step c, the powder B obtained in step b is pressed into a disk, and the formed disk is cold isostatic pressed and sintered at high temperature to obtain a high-temperature thermistor ceramic, which does not contain platinum electrode;

step d, the material sintered in step c is coated with platinum paste electrode on both sides, the thickness of the electrode is 2-3 mm, and then annealed to obtain a low-B high-resistance wide temperature range high-temperature thermistor.

In step c, powder B is pressed to a disk at a pressure of 10-20 Kg/cm² for 0.5-2 min, the formed disk is held at a pressure of 300-400 Mpa for 1-3 min for cold isostatic pressing, and then sintered at a temperature of 1200-1400° C. for 6-10 hours to produce high temperature thermistor.

Among them, annealing in step d is at 900° C. for 30 minutes.

As the best choice, the high-temperature thermistor material with low-B and high resistance in wide temperature range is a high-temperature thermistor material with a temperature range of 25° C.-1000° C., material constant of B_{200° C./600° C.}=1800 K-4000 K, and resistivity at 25° C. of 8.0×10⁵ Ω·cm-6.0×10⁷ Ω·cm.

The thermistor material of the disclosure can be used to manufacture a wide temperature range high-temperature thermistor.

The disclosure designs and synthesizes a low-B high-resistance wide temperature range high-temperature thermistor material through rare earth Y doping and the change of CeNbO₄ content in combination with the solid solution characteristics of Ca—Ce—Nb—Mo—O.

The disclosure provides a new type of low-B high-resistance wide temperature range high-temperature thermistor material, which is made of CaCO₃, Nb₂O₅, CeO₂, MoO₃ and Y₂O₃, and can be obtained by mixing, grinding, calcining, cold isostatic pressing forming, high-temperature sintering and coating electrode; The chemical composition of the thermistor material is composed of Ca_{1-y}Y_{y}MoO₄-xCeNbO₄, in which 1≤x≤3, 0.01≤y≤0.2; Considering the high-temperature resistance of Y₂O₃ and the ion radius of Y³⁺ and Ca²⁺, the substitution of Y³⁺ for Ca²⁺ and the increase of high conductivity phase CeNbO₄ at the same time, the electrical properties of the thermistor material can be adjusted, and the electrical properties can be adjusted in the wide temperature range.

According to the semiconductor characteristics of CaMoO₄—CeNbO₄, the disclosure has synthesized Ca_{1-y}Y_{y}MoO₄-xCeNbO₄ wide temperature range (25° C.-1000° C.) high-temperature thermistor material through adjusting the CeNbO₄ content and the Y doping content.

Beneficial effect: compared with the prior art, the disclosure has the following advantages:

The high-temperature thermistor material with low-B high-resistance type and wide temperature range prepared by the disclosure adopts the solid-phase method to mix and grind, calcine, mix and regrind the oxides of Ca, Ce, Nb, Mo and Y to obtain the NTC thermistor powder material, and then the powder material is formed by cold isostatic pressing, and after high temperature sintering, the two sides are coated with platinum paste electrodes to obtain the thermistor material. The material constant of the thermistor is B_{200° C./600° C.}=1800 K-4000 K, and the resistivity at 25° C. is 8.0×10⁵ Ω·cm-6.0×10⁷ Ω·cm. The high-temperature thermistor material with low-B value high-resistance and wide temperature range prepared by the method of the disclosure has stable performance and good consistency. The thermistor material has an obvious negative temperature coefficient characteristic in the temperature range of 25° C.-1000° C., and is suitable for manufacturing high-temperature thermistor with a wide temperature range.

### BRIEF DESCRIPTION OF THE DRAWINGS

FIG. 1 is the XRD pattern of the thermistor ceramic material of the disclosure.

### DESCRIPTION OF THE EMBODIMENTS

The technical scheme of the disclosure will be described in detail below, but the protection scope of the disclosure is not limited to the embodiment.

### Example 1

step a, according to the composition of Ca_{0.8}Y_{0.2}MoO₄-3CeNbO₄, the analytical pure CaCO₃, Nb₂O₅, CeO₂, MoO₃ and Y₂O₃ are respectively weighed and mixed. The mixed raw materials are ground in the agate mortar for 8 hours to obtain the powder;

step b, calcine the ground powder in step a at 1100° C. for 3 hours, and grind it for 6 hours to obtain Ca_{0.8}Y_{0.2}MoO₄-3CeNbO₄ powder;

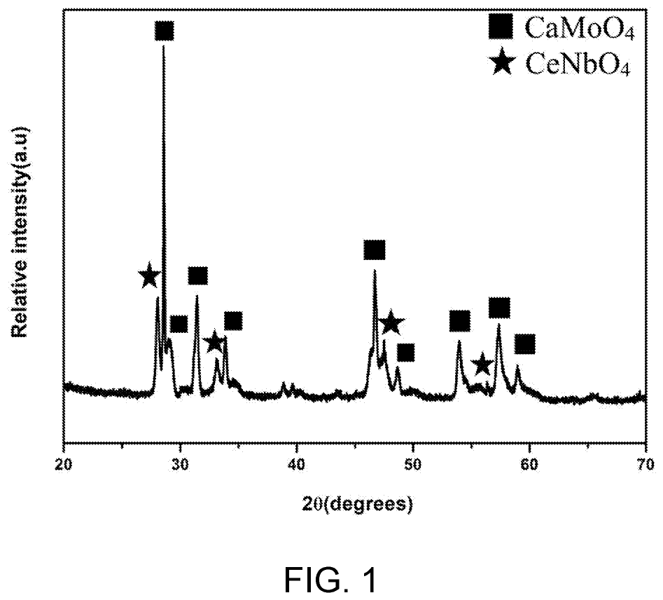

step c, the powder obtained in step b is pressed into a disk at a pressure of 20 Kg/cm² for 1 minute, and the disk is cold isostatic pressed for 3 minutes at a pressure of 300 Mpa, and then sintered at 1350° C. for 9 hours to produce a high temperature thermistor ceramic material. The phase structure is shown in FIG. 1, which is a composite structure, that is, CaMoO₄ phase and CeNbO₄ phase;

step d, the ceramic material sintered in step c is coated with platinum paste electrode on both sides, the thickness of the electrode was 2 mm, and then annealed at 900° C. for 30 minutes. The temperature range of the thermistor material is 25° C.-1000° C., the material constant B_{200° C./600° C.} is 1800 K, and the resistivity at 25° C. is 8.0×10⁵ Ω·cm.

### Example 2

step a, According to the composition of Ca_{0.9}Y_{0.1}MoO₄-2CeNbO₄, the analytical pure CaCO₃, Nb₂O₅, CeO₂, MoO₃ and Y₂O₃ are respectively weighed and mixed. The mixed raw materials are ground in the agate mortar for 5 hours to obtain the powder;

step b, Calcine the ground powder in step a at 1000° C. for 4 hours, and grind it for 10 hours to obtain Ca_{0.9}Y_{0.1}MoO₄-2CeNbO₄ powder;

step c, The powder obtained in step b is pressed into a disk at a pressure of 15 Kg/cm² for 0.5 minute, and the disk is cold isostatic pressed for 1 minutes at a pressure of 350 Mpa, and then sintered at 1400° C. for 6 hours to produce a high temperature thermistor ceramic material;

step d, The ceramic material sintered in step c is coated with platinum paste electrode on both sides, the thickness of the electrode was 2 mm, and then annealed at 900° C. for 30 minutes. The temperature range of the thermistor material is 25° C.-1000° C., the material constant B_{200° C./600° C.} is 2000 K, the resistivity at 25° C. is 3.0×10⁶ Ω·cm.

### Example 3

step a, According to the composition of Ca_{0.99}Y_{0.01}MoO₄-1CeNbO₄, the analytical pure CaCO₃, Nb₂O₅, CeO₂, MoO₃ and Y₂O₃ are respectively weighed and mixed. The mixed raw materials are ground in the agate mortar for 10 hours to obtain the powder;

step b, Calcine the ground powder in step a at 1050° C. for 5 hours, and grind it for 5 hours to obtain Ca_{0.99}Y_{0.01}MoO₄-1CeNbO₄ powder;

step c, The powder obtained in step b is pressed into a disk at a pressure of 10 Kg/cm² for 2 minute, and the disk is cold isostatic pressed for 2 minutes at a pressure of 400 Mpa, and then sintered at 1400° C. for 10 hours to produce a high temperature thermistor ceramic material;

step d, The ceramic material sintered in step c is coated with platinum paste electrode on both sides, the thickness of the electrode was 3 mm, and then annealed at 900° C. for 30 minutes. The temperature range of the thermistor material is 25° C.-1000° C., the material constant B_{200° C./600° C.} is 4000 K, the resistivity at 25° C. is 6.0×10⁷ Ω·cm.

### Example 4

step a, According to the composition of Ca_{0.85}Y_{0.15}MoO₄-2CeNbO₄, the analytical pure CaCO₃, Nb₂O₅, CeO₂, MoO₃ and Y₂O₃ are respectively weighed and mixed. The mixed raw materials are ground in the agate mortar for 6 hours to obtain the powder;

step b, Calcine the ground powder in step a at 1080° C. for 5 hours, and grind it for 8 hours to obtain Ca_{0.85}Y_{0.15}MoO₄-2CeNbO₄ powder;

step c, The powder B obtained in step b is pressed into a disk at a pressure of 10 Kg/cm² for 2 minute, and the disk is cold isostatic pressed for 3 minutes at a pressure of 300 Mpa, and then sintered at 1250° C. for 10 hours to produce a high temperature thermistor ceramic material;

step d, The ceramic material sintered in step c is coated with platinum paste electrode on both sides, the thickness of the electrode is 2 mm, and then annealed at 900° C. for 30 minutes. The temperature range is 25° C.-1000° C., the material constant B_{200° C./600° C.} is 1900 K, the resistivity at 25° C. is 1.5×10⁶ Ω·cm.

### Example 5

The preparation method of example 5 is the same as that of example 1, and the difference is that the composition of example 5 is Ca_{0.85}Y_{0.15}MoO₄-1.5CeNbO₄.

### Example 6

The preparation method of example 6 is the same as that of example 1, and the difference is that composition of example 6 is composed of Ca_{0.95}Y_{0.5}MoO₄-2.5CeNbO₄.

The performance parameters of the low-B high-resistance wide temperature range high-temperature thermistor material prepared in examples 5-6 are all in the following range: the temperature range is 25° C.-1000° C., the material constant B_{200° C./600° C.} is 1800 K-4000 K, the resistivity at 25° C. is 8.0×10⁵ Ω·cm-6.0×10⁷ Ω·cm.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A low-B high-resistance wide temperature range high-temperature thermistor material, wherein the thermistor material is prepared by CaCO₃, Nb₂O₅, CeO₂, MoO₃ and Y₂O₃, and the thermistor material is a composite oxide including Ca, Y, Mo, Ce and Nb.

2. The low-B high-resistance wide temperature range high-temperature thermistor material according to claim 1, wherein the chemical composition system is composed of Ca_{1-y}Y_{y}MoO₄-xCeNbO₄, wherein 1≤x≤3, 0.01≤y≤0.2.

3. The low-B high-resistance wide temperature range high-temperature thermistor material according to claim 1, wherein the molar ratio of Ca, Y, Mo, Ce and Nb is (0.8˜0.99):(0.01˜0.2): 1:(1˜3):(1˜3).

4. The low-B high-resistance wide temperature range high-temperature thermistor material according to claim 1, wherein the molar ratio of Ca, Y, Mo, Ce and Nb is (0.85˜0.95):(0.05˜0.15):1:(1.5˜2.5):(1.5˜2.5).

5. A preparation method of the low-B high-resistance wide temperature range high-temperature thermistor material according to claim 1, comprising the following steps:
step a, weigh CaCO₃, Nb₂O₅, CeO₂, MoO₃ and Y₂O₃, respectively and mix them, and grind the mixed raw materials for 5-10 hours to obtain powder A;
step b, calcine the powder A in step a at 1000° C.-1100° C. for 3-5 hours, and grind for 5-10 hours to obtain powder B;
step c, the powder B obtained in step b is pressed into a disk, and the formed disk is cold isostatic pressed and sintered at high temperature to obtain a high-temperature thermistor ceramic; and
step d, the material sintered in step c is coated with platinum paste electrode on both sides, the thickness of the electrode is 2-3 mm, and then annealed to obtain the low-B high-resistance wide temperature range high-temperature thermistor.

6. The preparation method of the low-B high-resistance type high-temperature thermistor material with wide temperature range according to claim 5, wherein in step c, the powder B is pressed to form a disk at a pressure of 10-20 Kg/cm² for 0.5-2 minutes, the formed disk is held at a pressure of 300-400 Mpa for 1-3 minutes for cold isostatic pressing, and then sintered at a temperature of 1200-1400° C. for 6-10 hours for preparation high-temperature thermistor ceramics.

7. The preparation method of the low-B high-resistance wide temperature range high-temperature thermistor material according to claim 5, wherein the annealing in step d is at 900° C. for 30 minutes.

8. The preparation method of the low-B high-resistance wide temperature range high-temperature thermistor material according to claim 5, wherein the prepared low-B high-resistance material is a wide temperature range high-temperature thermistor material with a temperature range of 25° C.-1000° C., a material constant of B_{200° C./600° C.}=1800 K-4000 K, and a resistivity at 25° C. of 8.0×10⁵ Ω·cm-6.0×10⁷ Ω·cm.

9. A preparation method of the low-B high-resistance wide temperature range high-temperature thermistor material according to claim 2, comprising the following steps:
step a, weigh CaCO₃, Nb₂O₅, CeO₂, MoO₃ and Y₂O₃, respectively and mix them, and grind the mixed raw materials for 5-10 hours to obtain powder A;
step b, calcine the powder A in step a at 1000° C.-1100° C. for 3-5 hours, and grind for 5-10 hours to obtain powder B;
step c, the powder B obtained in step b is pressed into a disk, and the formed disk is cold isostatic pressed and sintered at high temperature to obtain a high-temperature thermistor ceramic; and
step d, the material sintered in step c is coated with platinum paste electrode on both sides, the thickness of the electrode is 2-3 mm, and then annealed to obtain the low-B high-resistance wide temperature range high-temperature thermistor.

10. A preparation method of the low-B high-resistance wide temperature range high-temperature thermistor material according to claim 3, comprising the following steps:
step a, weigh CaCO₃, Nb₂O₅, CeO₂, MoO₃ and Y₂O₃, respectively and mix them, and grind the mixed raw materials for 5-10 hours to obtain powder A;
step b, calcine the powder A in step a at 1000° C.-1100° C. for 3-5 hours, and grind for 5-10 hours to obtain powder B;
step c, the powder B obtained in step b is pressed into a disk, and the formed disk is cold isostatic pressed and sintered at high temperature to obtain a high-temperature thermistor ceramic; and
step d, the material sintered in step c is coated with platinum paste electrode on both sides, the thickness of the electrode is 2-3 mm, and then annealed to obtain the low-B high-resistance wide temperature range high-temperature thermistor.

11. A preparation method of the low-B high-resistance wide temperature range high-temperature thermistor material according to claim 4, comprising the following steps:
step a, weigh CaCO₃, Nb₂O₅, CeO₂, MoO₃ and Y₂O₃, respectively and mix them, and grind the mixed raw materials for 5-10 hours to obtain powder A;
step b, calcine the powder A in step a at 1000° C.-1100° C. for 3-5 hours, and grind for 5-10 hours to obtain powder B;
step c, the powder B obtained in step b is pressed into a disk, and the formed disk is cold isostatic pressed and sintered at high temperature to obtain a high-temperature thermistor ceramic; and
step d, the material sintered in step c is coated with platinum paste electrode on both sides, the thickness of the electrode is 2-3 mm, and then annealed to obtain the low-B high-resistance wide temperature range high-temperature thermistor.

12. An application of the thermistor material according to claim 1 is in manufacturing wide temperature range high-temperature thermistor.

13. An application of the thermistor material according to claim 2 is in manufacturing wide temperature range high-temperature thermistor.

14. An application of the thermistor material according to claim 3 is in manufacturing wide temperature range high-temperature thermistor.

15. An application of the thermistor material according to claim 4 is in manufacturing wide temperature range high-temperature thermistor.
